(19) United States
(12) Patent Application Publication
(10) Pub. No.: US 2002/0168913 A1
(43) Pub. Date: Nov. 14, 2002

(54) Method of producing a color display tube with an improved color selection electrode

(76) Inventors: Johannes Petrus Wilhelmus Baaijens, Eindhoven (NL); Franciscus Johannes Gerardus Hakkens, Eindhoven (NL); Ronald Antonie Hovenkamp, Eindhoven (NL)

Correspondence Address: U.S. Philips Corporation, 580 White Plains Road, Tarrytown, NY, 10591, US

(21) Appl. No.: 10/127,555

(22) Filed: Apr. 22, 2002

(30) Foreign Application Priority Data
Apr. 25, 2001 (EP) 01201497.3

(51) Int. Cl. H01J 9/12

(52) U.S. Cl. 445/47

(57) ABSTRACT

One of the process steps in the manufacturing process of shadow masks (13) for color display tubes (1) is blackening. In this process step, the shadow mask (13) is heated for example to a temperature of at least 600° C. in a furnace in a gentle oxidative atmosphere of a mixture of carbon monoxide and carbon dioxide. Under these conditions the shadow mask (13) is covered with a layer of Fe₃O₄, also referred to as ‘black rust’. After this the shadow mask (13) is cooled down. The invention describes a new blackening process which has a much higher cooling rate than usual. In the present-day process, a cooling rate of 50° C./min (21) is used; this invention discloses a cooling rate of at least 500° C./min (22) or even more. This results in an improvement by at least 20% of the thermal expansion coefficient, leading to a color display tube (1) with a shadow mask (13) having a higher mechanical stability and hence to an increased picture performance.

The invention relates to a method of producing a color display tube with a display window and a color selection electrode comprising a shadow mask and a frame, which method comprises the process steps of forming the shadow mask from an apertured sheet, blackening said shadow mask in a furnace at a temperature of about at least 600° C. and coupling the shadow mask to the frame so as to form the color selection electrode which is suspended from the display window.

The invention further relates to a color display tube that is manufactured by using this method and to a color selection electrode for use in such a color display tube.

A method of producing a color display tube as described in the opening paragraph is disclosed in “Manufacturing of CRTs” by Daniel den Engelsen (SID Seminar Lecture Notes, Long Beach, Calif., May 15 and 19, 2000). This publication describes in section 2.3.1 the relevant process steps in the manufacture of a shadow mask. After the shadow mask is drawn in order to obtain the prescribed shape, it is blackened. In this process step the mask is heated to a temperature of at least 600° C. in a furnace in a gentle oxidative atmosphere of a mixture of carbon monoxide and carbon dioxide. Under these conditions the shadow mask is covered with a layer of Fe₃O₄, also referred to as ‘black rust’. This blackening process has a number of advantages, like for instance the high coefficient of radiation in the far infrared. During operation, the shadow mask is heated by electrons impinging on it, causing a deformation of the shadow mask. When the shadow mask is deformed, the shadowing effect of the shadow mask changes and consequentially, the electron beams do not hit the appropriate electroluminescent material on the display window. This misregistration causes a lack of the corresponding color, or even worse, the wrong color of electroluminescent material is excited. These misregistrations cause discoloration of the display tube that lead to a deterioration of the quality of the picture on the color display tube. Evidently, a high heat radiation of the shadow is of importance for the quality of the picture on a color display tube.

Color display tubes provided with the shadow mask as described in the prior art, in practice, show discolorations that are so large that the ever-increasing demand regarding picture quality cannot be met. Especially, wide screen tubes and tubes with a real flat or almost flat outer surface of the display window are burdened with these problems. It is a disadvantage of the known color display tube that it shows excessively large misregistrations.

It is an object of the invention to provide a color display tube having a shadow mask that improves on the shadow mask described in the opening paragraph and that substantially reduces the registration errors on the display window.

According to the present invention, this object is achieved with a color display tube which is characterized in that, after the process step of blackening, the shadow mask is cooled down at a cooling speed substantially higher than 50° C./min in order to obtain a significant decrease in thermal expansion coefficient of the shadow mask.

The invention is based on the recognition that the registration errors are reduced when the shadow mask shows fewer deformations during operation. One parameter that is of influence on the magnitude of the deformations in the shadow mask is the thermal expansion coefficient of the shadow mask. For that reason a lot of different materials have hitherto been investigated to find out whether they could suitably be used for a shadow mask in a color display tube. The most familiar materials are akoca steel and invar, which is an iron-nickel alloy.

This invention discloses a method of reducing the thermal expansion coefficient of the shadow mask that is determined by the shadow mask manufacturing process instead of by the choice of the material. In the commonly used process, after the blackening treatment the shadow mask is cooled down in the blackening furnace at a rate of about 50° C./min. It has been found that when this cooling rate is substantially increased, the thermal expansion coefficient is strongly reduced for invar type shadow masks.

In JP 10-130722, a blackening treatment is disclosed which is called a rapid cooling process. The aim of this process is to generate residual strains in the iron-nickel alloy after pressing. The rapid cooling rate as disclosed in JP 10-130722 is increased to about 35° C./min, so this cooling down rate is even lower than in the presently used blackening process, and hence of no relevance to the present invention.

A preferred embodiment is characterized in that, after the process step of blackening, the shadow mask is cooled down at a cooling rate of at least 500° C./min. It has been found that when the cooling rate is increased to a level of about 500° C./min, the thermal expansion coefficient is reduced by about 20% for invar-type shadow masks.

A further embodiment is characterized in that, after the process step of blackening, the shadow mask is cooled down at a cooling rate of at least 2000° C./min. By increasing the cooling rate to 2000° C./min, an even more impressive reduction of the thermal expansion coefficient can be obtained, namely about 35%. Although this solution is preferred from a performance point of view, it will be more difficult to realize in practice because it requires special process conditions.

In a further embodiment, the cooling rate is maintained between the temperature of the blackening process and 500° C.

In experiments it has been shown that the gain in thermal expansion coefficient is largest when the cooling rate is maintained at least in the first part of the cooling down trajectory, that is between the blackening temperature of about 600° C. and 500° C.

In a still further embodiment the cooling down of the color selection electrode is carried out in the open air.

From an industrial point of view it is very advantageous to do the cooling down in the open air. This is by far the easiest way of carrying out this process, because no additional equipment is required, only some space in the production line behind the blackening furnace.

Further embodiments are characterized in that the shadow mask is made of an Fe—Ni alloy, and in that the Fe—Ni alloy contains about 36% Ni.

As this rapid cooling down process is meant in particular for color display tubes that must fulfil the highest requirements with respect to picture quality, the best results are obtained when the material from which the shadow mask is manufactured already has a low thermal expansion coefficient. This is achieved by taking an iron-nickel (Fe—Ni) alloy, and especially an alloy with about 36% Ni, also known as invar.

A still further embodiment is characterized in that the thermal expansion coefficient of the shadow mask in the temperature range 20-100° C. is below 0.8*10⁻⁶/K.

Invar-type shadow masks made from material with a low manganese content, also referred to as improved invar, generally have a thermal expansion coefficient of about 1.0*10⁻⁶/K. A cooling rate of 500° C./min leads to a 20% reduction in thermal expansion coefficient, and a cooling rate of 3000° C./min even leads to a 35% reduction. So, a thermal expansion coefficient below 0.8*10⁻⁶/K can be realized.

The invention further relates to a color display tube that is manufactured by using this method and to a color selection electrode for use in such a color display tube.

These and other aspects of the invention are apparent from and will be elucidated by way of non-limitative examples with reference to the drawings and the embodiments described hereinafter.

In the drawings:

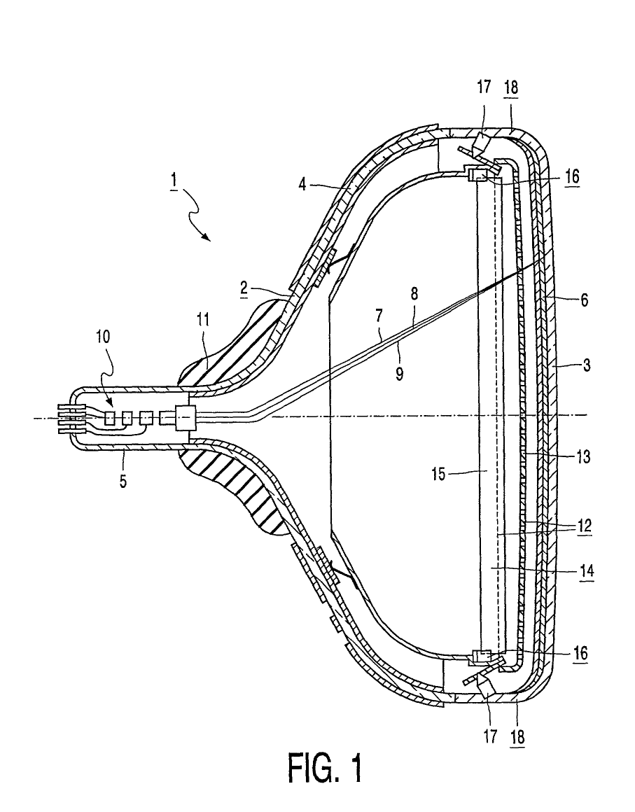

FIG. 1 is a sectional view of a color display tube according to the invention;

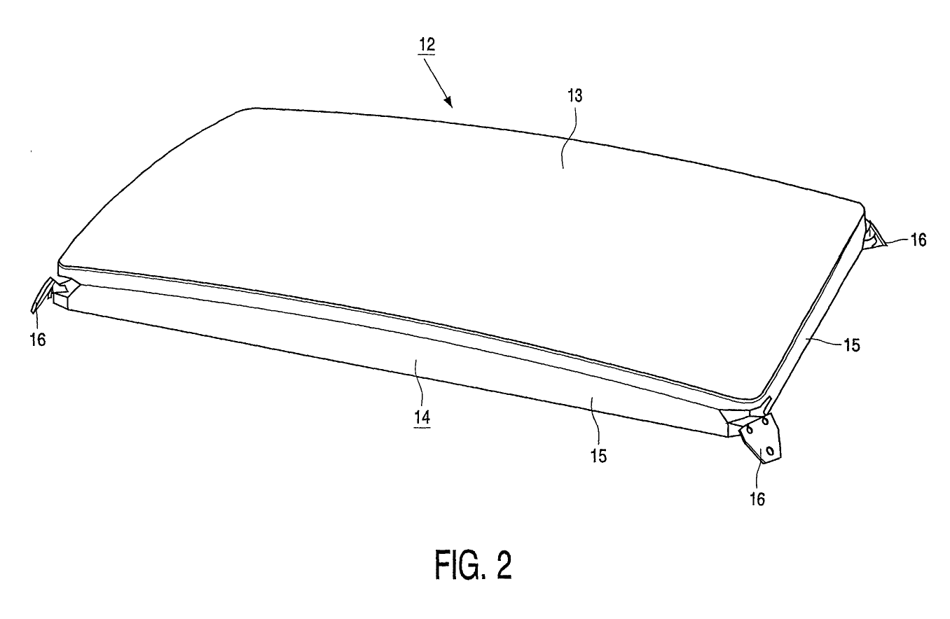

FIG. 2 is a schematic view of a color selection electrode;

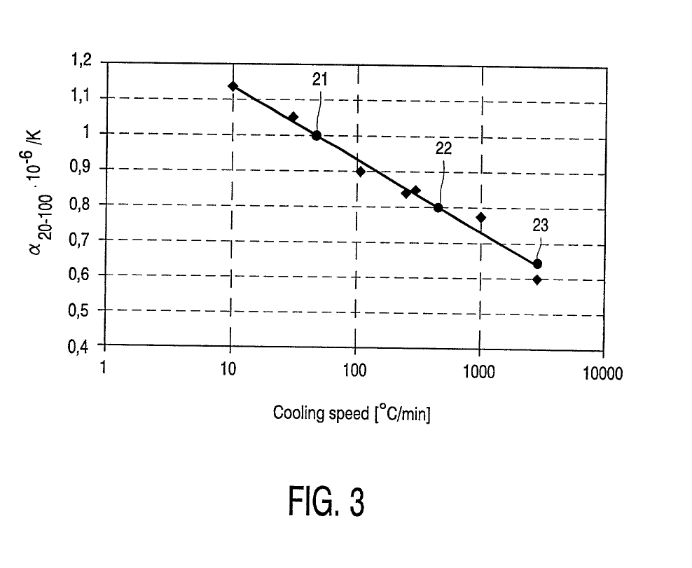

FIG. 3 gives the thermal expansion coefficient as a function of the cooling rate after blackening.

The color display tube 1 shown in FIG. 1 comprises an evacuated glass envelope 2 with a display window 3, a funnel shaped part 4 and a neck 5. On the inner side of the display window 3, a screen 6 having a pattern of for example lines or dots of phosphors luminescing in different colors (e.g. red, green and blue) may be arranged. The phosphor pattern is excited by the three electron beams 7, 8 and 9 that are generated by the electron gun 10. On their way to the screen the electron beams 7, 8 and 9 are deflected by the deflection unit 11, ensuring that the electron beams 7, 8 and 9 systematically scan the screen 6. Before the electrons hit the screen 6, they pass through a color selection electrode 12. This color selection electrode 12 comprises a shadow mask 13, which is the real color selective part: it intersects the electron beams so that the electrons only hit the phosphor of the appropriate color. The shadow mask 13 may be an apertured mask having circular or elongate apertures, or a wire mask. Furthermore, the color selection electrode 12 comprises the frame 14 for supporting the shadow mask 13.

In this example, as is shown in more detail in FIG. 2, the color selection electrode 12 is of the corner suspension type, so that the frame 14 comprises the corner sections 16 and the diaphragm parts 15 interconnecting the corner sections 16. The color selection electrode 12 is suspended from the display window 3 by using supporting elements 17, which are, in this example, secured in the upright edge of the corner areas 18 of the display window 3.

The manufacturing process of shadows masks 13 comprises a number of steps. It starts with a flat sheet of metal; commonly used materials are akoca (low carbon steel) and invar (an iron-nickel alloy containing about 36% of nickel). This sheet of metal is provided, by a photo-lithographic process followed by a chemical etching process, with a pattern of apertures. After annealing and re-crystallizing at a temperature between 800 and 900° C. under a mixed nitrogen-hydrogen atmosphere, the flat mask is finished.

In the next step, the mask is shaped so as to obtain the prescribed contour. This is done with a heavy pressing tool, with the distinction that akoca masks are drawn at room temperature and invar masks mostly at a temperature of about 200° C.; after which the masks are cleaned. The final process step is the blackening of the shadow mask, which is the subject of the present invention. When the shadow mask 13 is finished, the shadow mask and the frame 14 are assembled to form the color selection electrode 12.

In the prior art blackening process, the shadow mask 13 is heated for instance to a temperature of at least 600° C. in a furnace under a gentle oxidative atmosphere of a mixture of carbon monoxide and carbon dioxide. Alternatively, the blackening of the shadow mask 13 also takes place under a stronger oxidative atmosphere including free oxygen. In the present process, in which the oxidative atmosphere comprises a mixture of carbon monoxide, carbon dioxide, nitrogen, hydrogen, argon and watervapor, the watervapor is of great importance to the blackening. Under these conditions, the iron in the shadow mask is oxidized to form a layer of Fe₃O₄, also referred to as ‘black rust’. Then the shadow mask 13 is cooled down in the furnace at a rate of about 50° C./min. This blackening process increases the radiation of heat of the shadow mask during operation due to the high coefficient of emission of Fe₃O₄ in the far infrared. Furthermore, a Fe₃O₄ protects the shadow mask 13 against uncontrolled oxidation during the frit sealing process wherein the display window 3 and funnel shape part 4 are assembled.

In present-day color display tubes 1, picture quality is becoming more and more important. Evidently, the color purity plays a dominant role in picture quality. For that reason, it is essential that during operation the deformations of the shadow mask 13 are reduced to a minimum. One of the parameters contributing to a good mechanical stability of the shadow mask 13 is the thermal expansion coefficient of the shadow mask material. It goes without saying that when the thermal expansion coefficient is lower, the shadow mask, when heated by electrons impinging on it, will show fewer deformations. As a result, invar is preferred to akoca as the shadow mask material, because the thermal expansion coefficient is about a factor of 10 lower than that of akoca. A disadvantage of invar is its price, which is much higher than that of akoca.

Recently, a lot of research has been done on the development of new materials with a reduced thermal expansion coefficient with respect to that of invar. However, according to the invention, the thermal expansion coefficient can be lowered by a new blackening process. This new method does not require expensive new materials or complex equipment in the factory. This makes this method very attractive. The advantages are clear: a better picture quality at hardly any costs.

According to the invention, the thermal expansion coefficient of invar-type shadow masks can be significantly lowered by quickly cooling down the shadow mask 13 after the blackening process. In FIG. 3, the relation between the cooling rate in ° C./min and the thermal expansion coefficient for the temperature range between 20 and 100° C. has been given. For invar-type shadow masks, the measuring points in this Figure are obtained in a laboratory furnace. The shadow masks were blackened in the furnace, then quickly removed from the furnace and cooled in the open air. In this Figure, the cooling rate is derived from the cooling process between the blackening temperature and 500° C.

The currently used cooling rate of 50° C./min is indicated by point 21. At this cooling rate, the thermal expansion coefficient of invar is about 1.0*10⁻⁶/K. in the temperature range 20-100° C. By increasing the cooling rate an enormous decrease of the thermal expansion coefficient is obtained: 20% at a cooling rate of 500° C./min, see point 22, and even 35% at 3000° C./min, see point 23.

In the furnaces currently used for the blackening process, the shadow masks are also cooled down at the low cooling rate of 50° C./min. For the blackening process according to the invention, a cooling rate of 500° C./min is required; the easiest way to realize this is by cooling the shadow masks in the open air. This is an advantageous situation for a production environment because it hardly requires any equipment. Of course, also other rapid cooling methods can be applied, like for instance forced cooling by an air flow inside the blackening furnace or forced cooling outside the furnace. The heat emitted by shadow masks is so high that even for cooling speeds up to 3000° C./min, forced cooling can most likely be avoided.

This reduction of the thermal expansion coefficient when the shadow mask is rapidly cooled after the blackening process can be attributed to the fact that during the blackening process the mask is heated to temperatures about 600° C. This causes deficiencies and irregularities in the metal lattice of the shadow mask material. If the shadow mask 13 is cooled down, after the blackening process, at a low cooling rate, like for instance the frequently used 50° C./min, these lattice errors disappear again. However, at a high cooling down rate, for instance 500° C./min or even 2000° C./min, these lattice errors are ‘frozen’ and remain, leading to a significant decrease of the thermal expansion coefficient.

This method of rapidly cooling a blackened shadow mask is not restricted to shadow masks that are manufactured from an invar-type of material. It can also be applied to other mask materials, like for instance, cobalt containing iron-nickel alloys and other iron-nickel alloys with additives which may be used for lowering the thermal expansion coefficient. Furthermore, the iron-nickel alloys may be provided with additives for improving thermal conductivity, stiffness, yield stress and so on. Of course, it can also be applied to other metal parts inside a color display tube 1, like for instance the frame 14 or the inner magnetic shielding.

Furthermore, the method is not limited to a shadow mask with a particular pattern of apertures; it is also applicable to a shadow mask with a dotted pattern, a slotted pattern or to an aperture grill-type shadow mask.

Summarizing, one of the process steps in the manufacturing process of shadow masks 13 for color display tubes 1 is blackening. In this process step, the shadow mask 13 is heated for instance to a temperature of at least 600° C. in a furnace under a gentle oxidative atmosphere of a mixture of carbon monoxide and carbon dioxide. Under these conditions, the shadow mask 13 is covered with a layer of Fe₃O₄, also referred to as ‘black rust’. After this the shadow mask 13 is cooled down. The invention describes a new blackening process having a much higher cooling rate than usual. In the present-day process, a cooling rate of 50° C./min 21 is used; this invention discloses a cooling rate of at least 500° C./min 22 or even more. This leads to an improvement by at least 20% of the thermal expansion coefficient, leading to a color display tube 1 with a shadow mask 13 which has a higher mechanical stability and hence to an increased picture quality.

1. A method of producing a color display tube (1) with a display window (3) and a color selection electrode (12) comprising a shadow mask (13) and a frame (14), which method comprises the process steps of forming the shadow mask (13) from an apertured sheet, blackening said shadow mask (13) in a furnace at a temperature of about at least 600° C. and coupling the shadow mask (13) to the frame (14) so as to form the color selection electrode (12) which is suspended from the display window (3), characterized in that, after the process step of blackening, the shadow mask (13) is cooled down at a cooling rate substantially higher than 50° C./min in order to obtain a significant decrease in thermal expansion coefficient of the shadow mask (13)

2. A method according to claim 1, characterized in that, after the process step of blackening, the shadow mask (13) is cooled down at a cooling rate of at least 500° C./min.

3. A method according to claim 1, characterized in that, after the process step of blackening, the shadow mask (13) is cooled down at a cooling rate of at least 2000° C./min.

4. A method according to claim 1, 2 or 3, characterized in that the cooling rate is maintained between the temperature of the blackening process and 500° C.

5. A method according to claim 1, 2, 3 or 4, characterized in that the cooling down of the color selection electrode is carried out in the open air.

6. A method according to claim 1, 2, 3, 4 or 5, characterized in that the shadow mask (13) is made of an Fe—Ni alloy.

7. A method according to claim 6, characterized in that the Fe—Ni alloy contains about 36% Ni.

8. A method according to claim 7, characterized in that the thermal expansion coefficient of the shadow mask (13) in the temperature range 20-100° C. is below 0.8*10⁻⁶/K.

9. A color display tube (1) manufactured using the method as claimed in any one of the preceding claims.

10. A color selection electrode (12) for use in the color display tube (1) as claimed in claim 9.
